(19) United States
(12) Patent Application Publication
(10) Pub. No.: US 2006/0196183 A1
(43) Pub. Date: Sep. 7, 2006

(54) Supercharging assist control system and method

(75) Inventor: Nobumasa Isogai, Hekinan-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/335,714

(22) Filed: Jan. 20, 2006

(30) Foreign Application Priority Data
Mar. 1, 2005 (JP) 2005-56051

(51) Int. Cl. F02B 29/04; F02B 33/44

(52) U.S. Cl. 60/607; 60/599

(57) ABSTRACT

In an engine system having a motor-assisted supercharger, first and second supercharge-assist controls are performed. The first supercharge-assist control performs the supercharge-assist by an assist motor based upon a supercharge-assist amount for improving the follow-up characteristics of the actual supercharging pressure and the acceleration responsiveness to the rapid acceleration request by a driver. The second supercharge-assist control performs the supercharge-assist by the assist motor based upon the supercharge-assist amount for improving the convergent characteristics of the actual supercharging pressure to the target supercharging pressure.

### CROSS REFERENCE TO RELATED APPLICATION

This application is based on and incorporates herein by reference Japanese Patent Application No. 2005-56051 filed on Mar. 1, 2005.

### FIELD OF THE INVENTION

The present invention relates to a supercharge-assist control system, which increases an actual supercharging pressure by assisting a supercharging operation of a turbocharger with an electric motor. More particularly, the present invention relates to a turbocharger control apparatus with an electric motor in, which electric power supplied to the electric motor capable of electrically driving a compressor of the turbocharger is controlled to regulate a rotational speed of the. electric motor, thereby producing a predetermined supercharge-assist amount in accordance with the supplied electric power to the electric motor.

### BACKGROUND OF THE INVENTION

In a vehicle such as an automobile, for the purpose of producing a high engine output or achieving a low fuel consumption, an engine is provided with a supercharger to supercharge air taken into a cylinder of the engine by a turbocharger. Herein, the turbocharger is a supercharger, which rotates a turbine by utilizing exhaust gas energy (exhaust gas pressure) of an exhaust gas flown out from the engine to drive a compressor disposed co-axially with this turbine, thus supercharging the intake air. Therefore, since supercharging pressure response is poor in a region of a low engine rotational speed and an actual supercharging pressure results in a low value, charging efficiency is insufficient, thus leading to insufficient improvement in the engine output.

In order to solve the above drawbacks, another turbocharger control apparatus is provided with an electric motor (supercharge-assist control system), in which a turbine shaft of the turbocharger is connected to and driven by the electric motor. In this supercharge-assist control system, electric power (electric power: KW) supplied to the electric motor is determined based upon a deviation between a target supercharging pressure and an actual supercharging pressure, and the determined electric power is supplied to the electric motor to control a rotational speed of the electric motor. Thus, a predetermined supercharge-assist amount corresponding to the electric power to the electric motor is attained. Accordingly, when torque-up of the engine is needed, it is possible to quickly increase the actual supercharging pressure by assisting a supercharging operation of a compressor of the turbocharger with the electric motor.

In the conventional supercharge-assist control system, when an accelerator pedal is depressed by a driver to make an acceleration, the following process is performed during a period of from a point when the driver actually depresses the accelerator pedal to a point when a supercharge-assist is started by an electric motor as shown in FIG. 11: a first step of recognizing a depressing amount of the accelerator pedal (a change amount of an accelerator position per unit time, that is, a rate of change of an accelerator position); a second step of determining a fuel injection amount (target injection amount) based upon an engine rotational speed and the accelerator position; a third step of determining a target supercharging pressure based upon the engine rotational speed and the target injection amount; a fourth step of recognizing an actual supercharging pressure based upon an electric signal outputted from a supercharging pressure sensor; a fifth step of recognizing a deviation between the target supercharging pressure and the actual supercharging pressure; a sixth step of determining a supercharge-assist amount based upon the deviation between the target supercharging pressure and the actual supercharging pressure; and a seventh step of determining electric power to the electric motor corresponding to the supercharge-assist amount. With this process, an engine output (for example, engine torque, an engine rotational speed or the like) is increased. However, a time lag (response lag) occurs between when the acceleration request is made and when the supercharge-assist is actually started by the electric motor. Therefore, a vehicle driver feels a turbo lag regardless of the electric motor is mounted to the turbocharger.

For the purpose of improving acceleration response characteristic at the time of a driver's acceleration request, for example, JP-A-1-117931 proposes a turbocharger provided with an electric motor (supercharge-assist control system) which is provided with a depressing position-detecting device for detecting a depressing position of an accelerator pedal, and a depressing speed-detecting device for detecting a depressing speed of the accelerator pedal. When the depressing speed of the accelerator pedal is rapid, it is determined that the acceleration request is made. Thereby the electric power to the electric motor is set to a maximum value, causing an improvement in acceleration response to the acceleration request. In this control method, when the accelerator pedal is depressed to a maximum, a supercharge-assist amount (electric power to the electric motor) by the electric motor is continuously set to a maximum value (the maximum supercharge-assist amount) until the supercharging pressure reaches the maximum value.

Further, a still another turbocharger with an electric motor (supercharge-assist control system) is proposed. In this system, when a rate of change of an accelerator position is more than a predetermined value, it is determined that an acceleration request is made, and a maximum power supply amount is determined as a power supply amount at an initial period of starting the power supply to the electric motor to provide the determined maximum power supply amount to the electric motor for a period until an actual supercharging pressure exceeds a target supercharging pressure, thereby improving response characteristic of the actual supercharging pressure at the time of supercharge-assisting by the electric motor (for example, U.S. Pat. No. 6,880,337: JP-A-2004-169629, Pages 1 to 9, FIGS. 1 and 2). In this control method, however, the maximum power supply amount is provided to the electric motor for a period until the actual supercharging pressure exceeds the target supercharging pressure. Therefore, the actual supercharging pressure overshoots in the direction of exceeding the target supercharging pressure. This possibly causes deterioration of convergent characteristics of the actual supercharging pressure to the target supercharging pressure.

Accordingly, in both of the above conventional supercharge-assist control systems, the following operations (1) and (2) cannot be attained the same time:
(1) the follow-up characteristics of the actual supercharging pressure and acceleration responsiveness to the acceleration request for the purpose that the actual supercharging pressure quickly follows the target supercharging pressure which is immediately set at a high value based upon a rapid change of an engine operating condition caused by an acceleration request by a driver; and
(2) the convergent characteristics of the actual supercharging pressure to the target supercharging pressure for the purpose that the actual supercharging pressure smoothly and quickly converges to the target supercharging pressure without overshooting in the direction of exceeding the target supercharging pressure.

### SUMMARY OF THE INVENTION

The present invention is therefore directed to a supercharge-assist control system capable of achieving both an improvement in follow-up characteristics of an actual supercharging pressure and acceleration responsiveness to an acceleration request and an improvement in convergent (converging) characteristics of the actual supercharging pressure to a target supercharging pressure. It is further directed to a supercharge-assist control system capable of achieving a further improvement in acceleration performance by starting supercharge-assist with an electric motor immediately from a time point when a driver depresses an accelerator pedal.

According to an aspect of the present invention, when an acceleration request is made, a first supercharge-assist control or a second supercharge-assist control is selectively attained based upon a rate of change of an engine operating condition per unit time, a deviation between the actual supercharging pressure and the target supercharging pressure or elapse time from a point when the acceleration request is made. The first control performs supercharge-assist with an electric motor based upon a supercharge-assist amount for improving follow-up characteristics of an actual supercharging pressure and acceleration responsiveness to the acceleration request. The second control performs supercharge-assist with the motor based upon the supercharge-assist amount for improving convergent characteristics of the actual supercharging pressure to a target supercharging pressure. Thus, both an improvement in the follow-up characteristics of the actual supercharging pressure and the acceleration responsiveness to the acceleration request and an improvement in the convergent characteristics of the actual supercharging pressure to the target supercharging pressure can be achieved at the same time.

### BRIEF DESCRIPTION OF THE DRAWINGS

The above and other objects, features, aspects and advantages of the present invention will become apparent from the following detailed description made with reference to the accompanying drawings. In the drawings:

FIG. 1 is a schematic diagram showing an engine with a turbocharger and its peripheral equipment in a first preferred embodiment of the present invention;

FIG. 2 is a block diagram showing a control system of an engine control system with the turbocharger in the first preferred embodiment;

FIG. 3 is a flow chart showing a control method of the engine control system with the turbocharger in the first preferred embodiment;

FIG. 4 is a flow chart showing a control method of a first supercharge-assist control in the first preferred embodiment;

FIG. 5 is a flow chart showing a control method of a second supercharge-assist control in the first preferred embodiment;

FIG. 6 is a timing chart showing follow-up characteristics of an actual supercharging pressure and acceleration responsiveness to an acceleration request and convergent characteristics of the actual supercharging pressure to a target supercharging pressure in the first preferred embodiment;

FIG. 7 is a block diagram showing a control logic of ECU in a second preferred embodiment of the present invention;

FIG. 8A to FIG. 8C are timing charts, each showing a calculation period of a supercharge-assist amount SCA and SCB in the second preferred embodiment;

FIG. 9 is a timing chart showing a change of a depressing position of an accelerator pedal and a change of the supercharge-assist amount in the second preferred embodiment;

FIG. 10 is a schematic diagram showing an engine with a turbocharger and its peripheral equipment in a third preferred embodiment of the present invention;

FIG. 11 is a timing chart showing a change of each of a depressing position of an accelerator pedal, a target injection amount, a supercharging pressure and an engine rotational speed in the conventional art.

### DETAILED DESCRIPTION OF THE PREFERRED EMBODIMENTS

### First Preferred Embodiment

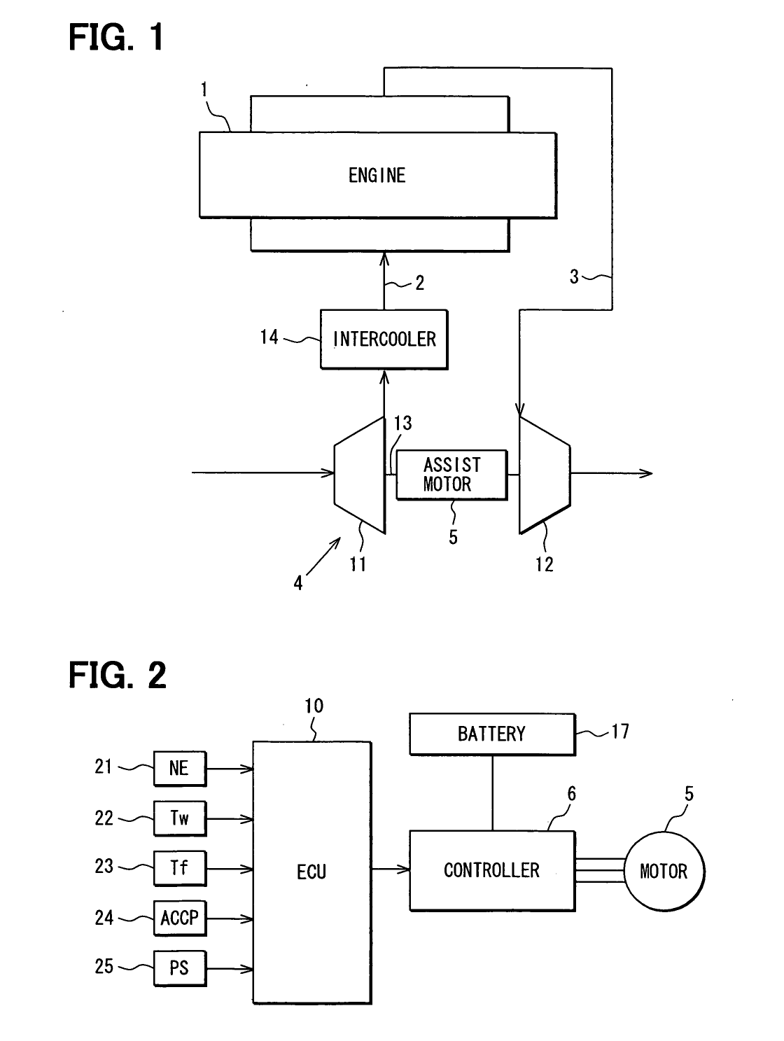

Referring first to FIGS. 1 and 2, an internal combustion engine 1 such as a diesel engine is provided with a turbocharger 4 for supercharging intake air supplied to a combustion chamber (not shown) of each cylinder for the engine 1, by using exhaust gas energy of an exhaust gas flown out from the engine 1. The engine 1 is further provided with an electric power generating motor as an assist motor 5 for performing supercharge-assist operation by electrically driving the turbocharger 4, and an engine electronic control unit (ECU) 10 housing a motor control apparatus therein for regulating a rotational speed of the assist motor 5 by controlling electric power to the assist motor 5.

The engine 1 is a direct injection diesel engine in which fuel is injected directly into a combustion chamber and is provided with an engine intake pipe 2 and an engine exhaust pipe 3 each communicated with the combustion chamber of each cylinder for the engine 1. An intake valve (not shown) for opening/closing -an intake port and an exhaust valve (not shown) for opening/closing an exhaust port are mounted to the engine 1. The intake port of the engine 1 is so constructed that intake air is supplied to the intake port via intake passages formed in the engine intake pipe 2 including an intake manifold. In addition, the exhaust port of the engine 1 is so constructed that an exhaust gas is supplied to the exhaust passages formed in the engine exhaust pipe 3 including an exhaust manifold.

Further, a common rail fuel injection apparatus for injecting/supplying high-pressure fuel (not shown) into the combustion chamber of each cylinder for the engine 1 is disposed in the engine control system with the turbocharger. The common rail fuel injection apparatus is provided with a common rail (not shown) for storing under pressure high-pressure fuel equivalent to an injection pressure of fuel, a supply pump (fuel injection pump: not shown) which highly pressurizes the fuel suctioned into a pressure chamber via a suction control valve (SCV: not shown) as an actuator to supply the high-pressure fuel to the common rail under pressure and a plurality of injectors (INJ: not shown) for injecting/supplying the high-pressure fuel stored in the common rail into the combustion chamber of each cylinder for the engine 1. Each of the plurality of the injectors is provided with an actuator such as an electromagnetic valve which drives a nozzle needle (valve body) in the opening direction.

The turbocharger 4 is provided with a compressor 11 disposed in the halfway of the engine intake pipe 2 and a turbine 12 disposed in the halfway of the engine exhaust pipe 3. The turbine 12 rotates integrally with the compressor 11 via a rotor shaft (turbine shaft) 13. Herein, an air cooled type or water cooled type intercooler 14 is disposed in the halfway of the engine intake pipe 2 for cooling intake air, which is compressed (supercharged) by the compressor 11 of the turbocharger 4 to have an increased temperature. In addition, an air filter is received in an air cleaner case (not shown) disposed in the most upper stream side of the engine intake pipe 2 for trapping foreign matters in intake air.

The compressor 11 is mounted at one end portion of the rotor shaft 13 in the central axis direction (axial direction) and is provided with a compressor wheel including a plurality of compressor blades. The compressor wheel is rotatably received in a compressor housing in such a way as to supercharge intake air flowing in the engine intake pipe 2. In addition, an intake air supply path to be formed in the compressor housing is formed in a spiral shape along the rotational direction of the compressor wheel so as to surround an outer periphery of the compressor wheel.

The turbine 12 is mounted at the other end portion of the rotor shaft 3 in the axial direction and is provided with a turbine wheel including a plurality of turbine blades. The turbine wheel is rotatably received in a turbine housing in such a way as to rotate by an exhaust gas flowing in the engine exhaust pipe 3. In addition, an exhaust gas discharge path to be formed in the turbine housing is formed in a spiral shape along the rotational direction of the turbine wheel so as to surround an outer periphery of the turbine wheel. An assist motor 5 is mounted between the compressor 11 and the turbine 12 and also in the central portion of the rotor shaft 13 in the axial direction in the first preferred embodiment.

The assist motor 5 is an electric motor-generator equipped with a function as an electric motor which performs supercharge assist operation by rotating/driving the compressor 11 and the turbine 12 by rotating the rotor shaft 13 and a function as an electric generator which performs regenerative power generation by being rotated/driven by exhaust gas energy of the engine 1. The assist motor 5 is an alternating current motor such as a three-phase induction electric motor-generator composed of a rotor integral with the rotor shaft 13 and a stator disposed in a side of an outer periphery of the rotor as opposed thereto, where a rotor core having a permanent magnet is disposed in the rotor and a stator core on which a three-phase stator coil is wound is disposed in the stator. The assist motor 5 serves as an electric motor when the supercharge-assist is needed. At this time, the assist motor 5 is connected electrically to the ECU 10 via an electronic controller (electric power conversion part) 6. In addition, the assist motor 5 serves as an electric generator when the supercharge-assist is not needed. At this time, the assist motor 5 is connected electrically to a battery 17 or other electric devices mounted on a vehicle via the controller 6.

Herein, ECU 10 shown in FIG. 2 is provided with a known microcomputer which is constructed of a CPU for performing control processing and calculation processing, a memory device (a volatile memory such as a SRAM and a DRAM, and a nonvolatile memory such as an EPROM, an EEPROM or a flash memory) for storing control programs or control logic and data, an input circuit, an output circuit, a power source circuit and the like. The ECU 10 is designed to perform feedback control so that when an ignition switch is on, for example, each of a fuel pressure (common rail pressure) in the common rail, an actual supercharging pressure (an actual intake pressure) and the like acts as a control command value based upon the control program or the control logic stored in the memory.

In addition, a pump drive circuit for applying a suction control valve drive current to a suction control valve (SCV) of the supply pump and an injector drive circuit for applying an injector drive current to an electromagnetic valve of the injector (INJ) are disposed between the ECU 10 and the actuator of each system. Further, the controller 6 is disposed between the ECU 10 and the assist motor 5 of the turbocharger 4. The controller 6 is provided with a DC-DC converter for boosting direct-current electric power from the battery 17, an inverter for variably controlling a rotational speed of the assist motor 5 by converting the boosted direct-current electric power to an alternating current electric power having a predetermined frequency and a rectifying circuit for rectifying an alternating current to be outputted from the three-phase stator coil of the assist motor 5 for the direct current.

The DC-DC converter can produce a stable battery voltage by reducing and smoothing the direct current outputted from the rectifying circuit. The inverter is a rotational speed control device for controlling a rotational speed of the rotor shaft 13 of the assist motor 5 by varying electric power (for example, a drive current value=output current value of the inverter) to the three-phase stator coil of the assist motor 5 based upon a control signal from the ECU 10. The controller 6 have a function to calculate a rotational speed of the rotor shaft 13 of the turbocharger 4 (or the assist motor 5) based upon the electric power to the three-phase stator coil of the assist motor 5. A rotational speed sensor for converting the rotational speed of the rotor shaft 13 of the turbocharger 4 (or the assist motor 5) to an electric signal for the outputting may be disposed.

The ECU 10 is designed in such a way that signals of various sensors such as a crank angle sensor 21 for detecting a crankshaft rotational angle of the engine 1, a water temperature sensor 22 for detecting an engine water temperature Tw and a fuel temperature sensor 23 for detecting a fuel temperature Tf are converted analog to digital by an A/D converter, which thereafter are inputted into the microcomputer housed in the ECU 10. The crank angle sensor 21 is formed of a pick-up coil for converting the crankshaft rotational angle of the engine 1 into an electric signal, for example, outputs a NE pulse signal at each 30 degrees CA (crank angle). The ECU 10 serves as a rotational speed detecting device for detecting an engine rotational speed (engine rotation speed: NE) by measuring an interval time between NE pulse signals outputted from the crank angle sensor 21.

The ECU 10 converts an accelerator operation amount (a depressing amount of an accelerator pedal) ACCP by a driver into an electric signal (accelerator position signal) and is connected to an accelerator position sensor 24 for outputting to the ECU 10 how much the accelerator pedal is depressed. The electric signal (accelerator position signal) to be outputted from the accelerator position sensor 24 is converted analog to digital by the A/D converter, which thereafter, is inputted to the microcomputer like the other sensors. And to the ECU 10, a supercharging pressure sensor for detecting a supercharging pressure Ps of intake air supercharged by the turbocharger 4, i.e., an actual supercharging pressure generated in the engine intake pipe 2 by the turbocharger 4 is connected. The electric signal (sensor signal) to be outputted from the supercharging pressure sensor 25 is converted analog to digital by the A/D converter, which thereafter, is inputted to the microcomputer like the other sensors. Note that the supercharging pressure sensor 25 converts an intake pressure (an actual supercharging pressure, an actual intake pressure) in the engine intake pipe 2 to an electric signal, which is outputted.

In addition, the ECU 10 has a function (injection amount setting device) of calculating a command injection amount (target injection amount: QFIN) by applying an injection amount correction amount including an engine water temperature, a fuel temperature or the like to a basic injection amount Q set corresponding to an engine rotational speed NE and an accelerator position ACCP, a function (injection timing setting device) of calculating command injection timing TFIN based upon the engine rotational speed NE and the target injection amount QFIN, and a function (injection period setting device) of calculating an injection command pulse length (=injection amount command value, command injection period: TQFIN) equivalent to a power supply time to the electromagnetic valve of the injector by the target injection amount QFIN and a fuel pressure (common rail pressure: PC) in the common rail to be detected by the fuel pressure sensor (not shown) disposed in the common rail.

In addition, the ECU 10 calculates an optimal injection pressure of fuel in accordance with operating conditions of the engine 1 and includes a fuel pressure control device for driving a suction control valve of the supply pump via a pump drive circuit. The ECU 10 includes a function (fuel pressure setting device) of calculating a target fuel pressure PFIN based upon the target injection amount QFIN and the engine rotational speed NE and, in order to achieve the target fuel pressure PFIN, is arranged so as to adjust a pump drive current applied to the suction control valve to feedback-control a fuel discharge amount to be discharged from the supply pump.

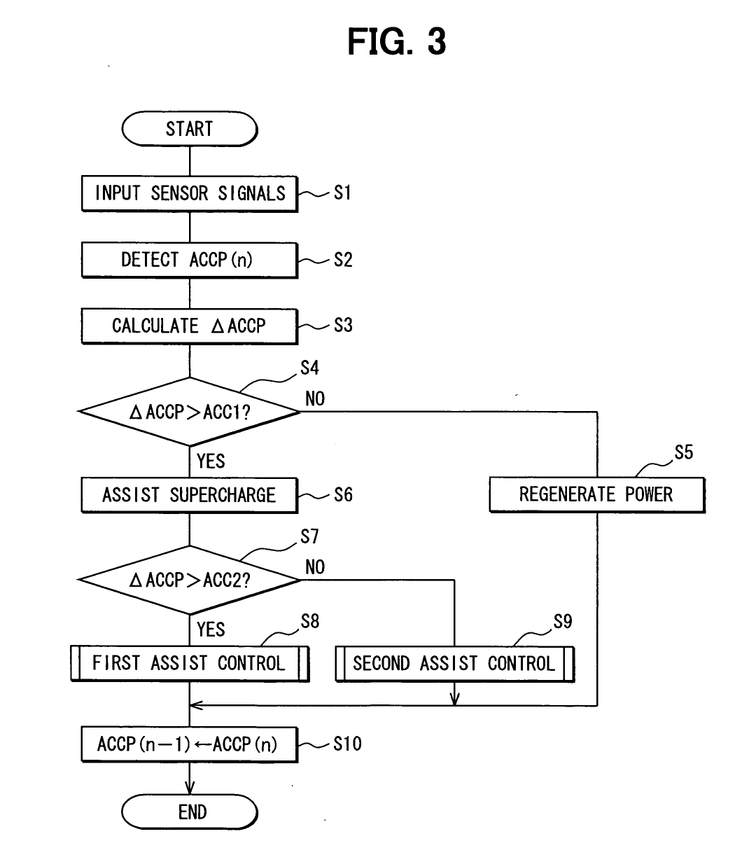

Next, a control method of the engine control system with the turbocharger in the first preferred embodiment will be explained with reference to FIGS. 3 to 5. A control routine in FIG. 3 is repeated for each predetermined control cycle after an ignition switch is turned on.

First, at step S1, signals of various sensors required for calculating operating states or conditions of the engine 1, engine operating information and operating information of each system are inputted. In more detail, an engine rotational speed is read in. Herein, the engine rotational speed is detected by measuring an interval time between NE pulse signals outputted from the crank angle sensor 21. Next, at step S2, the present value ACCP(n) of a depressing position of the accelerator pedal is detected from an electric signal (accelerator position signal) outputted from the accelerator position sensor 24, i.e., from the accelerator position. If the accelerator position is inputted at step S1, the detection processing at step 2 can be eliminated.

Next, at step S3, the previous value ACCP(n-1) of the depressing position of the accelerator pedal stored in the volatile memory such as the DRAM or the nonvolatile memory such as the EEPROM by the time of the previous control cycle is inputted and a deviation ΔACCP between the present value ACCP(n) of the depressing position of the accelerator pedal and the previous value ACCP(n-1) of the depressing position of the accelerator pedal is calculated. Alternatively, a rate of change of the accelerator position is calculated from an electric signal (accelerator position signal) to be outputted from the accelerator position sensor 24, i.e., from the accelerator position. Herein, the rate of change of the accelerator position may be calculated from an amount of change of the accelerator position per unit time detected from the accelerator position sensor 24 (accelerator position change amount).

Next, for the purpose of determining whether or not an acceleration request is made by a driver, it is determined whether or not the accelerator pedal is depressed by a driver. In more detail, it is determined whether or not the deviation ΔACCP between the present value ACCP(n) of the depressing position of the accelerator pedal and the previous value ACCP(n-1) of the depressing position of the accelerator pedal is greater than a first predetermined value. Alternatively, it may be determined whether or not the rate of change of the accelerator position is greater than a first predetermined value (acceleration request determination device: step S4) ACC1. The determination processing at step S4, for the purpose of determining whether or not the supercharge-assist is needed, it may be determined whether the engine rotational speed is at a low rotational speed region or at a high rotational speed region.

When the determination result at step S4 is NO, it is determined that the acceleration request is not made by the driver and the engine is at a steady state or at a decelerating state, which does not require the supercharge-assist. Therefore, at step S5, the assist motor 5 is driven into a regenerative power generating mode where it is rotated and driven by the turbocharger 4. Herein, at step S5, a regenerative power generating mode flag may be turned on and a supercharge-assist mode flag may be turned off.

That is, when the three-phase stator coil of the assist motor 5 is switched on till the previous control cycle, the power to the three-phase stator coil of the assist motor 5 is turned off. On the other hand, when the power to the three-phase stator coil of the assist motor 5 is turned off by the time of the previous control cycle, the power to the three-phase stator coil of the assist motor 5 continues to be turned off. Thereafter, the process proceeds to step S10.

In this way, the electric power regenerated by the assist motor 5 is returned to the battery via the rectifying circuit of the controller 6, the DC-DC converter or the like. If the returned electric power is effectively used so as to compensate for a part of power consumption of various electrical devices, electrical loads of the various electrical devices can be largely reduced. Therefore, a drive load of an alternator as an engine auxiliary machine rotated and driven by the engine 1 is reduced by the electric power regenerated by the assist motor 5, leading to an improvement of a fuel economy. At the regenerative power generating mode, the turbocharger 4 serves as a normal turbocharger using only exhaust gas energy of the exhaust gas flown out from the engine 1.

In addition, when the determination result at step S4 is YES, it is determined that the acceleration request is made by the driver and the engine 1 is at an accelerating state which requires the supercharge-assist, and therefore, at step S6, the assist motor 5 is driven into a supercharge-assist mode where the compressor 11 and the turbine 12 of the turbocharger 4 are rotated and driven by the assist motor 5. Herein, at step S6, the supercharge-assist mode flag may be turned on and the regenerative power generating mode flag may be turned off. In addition, the control processing at step S6 may be eliminated.

Next, for the purpose of determining whether or not a rapid acceleration request is made by a driver, it is determined whether or not the accelerator pedal is depressed by a driver. In more detail, it is determined whether or not the deviation ΔACCP between the present value ACCP(n) of the depressing position of the accelerator pedal and the previous value ACCP(n-1) of the depressing position of the accelerator pedal is greater than a second predetermined value ACC2, which is greater than the first predetermined value ACC1. Alternatively, it may be determined whether or not the rate of change of the accelerator position is greater than the second predetermined value, the second predetermined value being greater than the first predetermined value (acceleration request determination device: step S7).

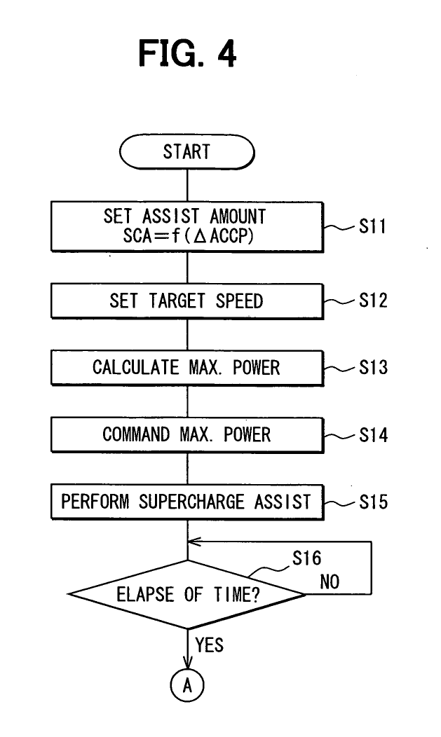

When the determination result at step S7 is YES, it is determined that the rapid acceleration request is made by the driver. For example, it is determined that the accelerator pedal is depressed by a large margin by a driver, a target supercharging pressure is set to a value much higher than the present actual supercharging pressure, and the actual supercharging pressure only with the turbocharger 4 is very insufficient for the target supercharging pressure. Therefore, the control routine (first supercharge-assist control) in FIG. 4 is performed (step S8). Then, the process proceeds to step S10.

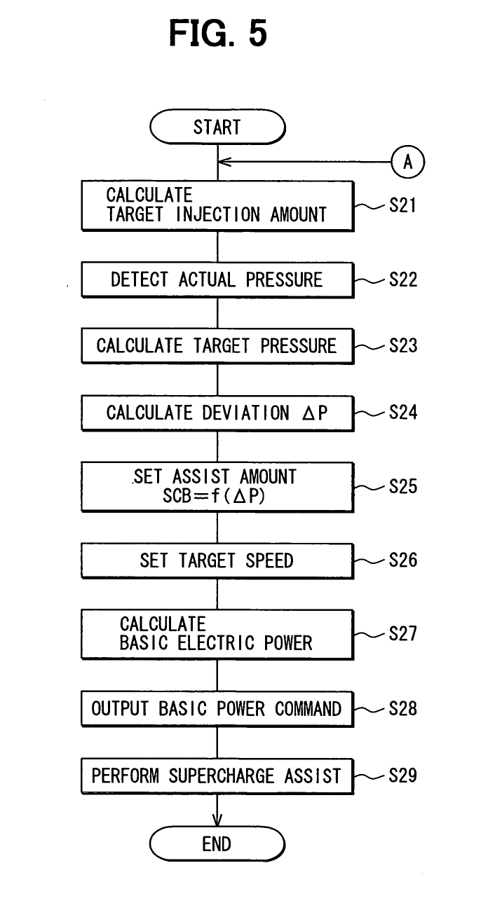

When the determination result at step S7 is NO, it is determined that a slow acceleration request is made by the driver. For example, it is determined that the accelerator pedal is depressed a little by a driver, a target supercharging pressure is set to a value a little higher than the present actual supercharging pressure, and the actual supercharging pressure only with the turbocharger 4 is a little insufficient for the target supercharging pressure. Therefore, the control routine (second supercharge-assist control) in FIG. 5 is performed (step S9). Next, the present value ACCP(n) of the depressing position of the accelerator pedal is converted to the previous value ACCP(n-1) of the depressing position of the accelerator pedal, which updates the volatile memory such as the DRAM or the nonvolatile memory such as the EEPROM for being stored (step S10). Thus, the control routine in FIG. 3 ends.

FIG. 4 is a flow chart showing a first supercharge-assist control method of performing supercharge-assist by the assist motor 5 based upon a supercharge-assist amount SCA for improving follow-up characteristics of an actual supercharging pressure and acceleration responsiveness to an acceleration request. A control routine in FIG. 4 continues to be performed until a predetermined time elapses at the time of a rapid acceleration request by a driver.

First, the supercharge-assist amount SCA is set based upon the deviation ΔACCP between the present value ACCP(n) of the depressing position of the accelerator pedal and the previous value ACCP(n-1) of the depressing position of the accelerator pedal or the rate of change of the accelerator position (first assist amount determination device: step S11). This supercharge-assist amount SCA is calculated as a supercharge-assist amount for improving follow-up characteristics of the actual supercharging pressure and acceleration responsiveness to the acceleration request.

Next, at step S12, a target rotational speed corresponding to the supercharge-assist amount SCA calculated at step S11 is set. Next, at step S13, the maximum electric power (the maximum value of the electric power=maximum value of a drive current value=maximum value of an output current value of the inverter) to the three-phase stator coil of the assist motor 5 required for making a motor speed (actual rotational speed) of the assist motor 5 be nearly equal to a target rotational speed is calculated. Next, at step S14, the maximum electric power command is outputted to the controller 6 from the ECU 10.

Thereby, the controller 6 supplies the maximum electric power to the three-phase stator coil of the assist motor 5 calculated at step S13, to the three-phase stator coil of the assist motor 5. That is, a supercharge-assist is performed by the assist motor 5 based upon the supercharge-assist amount SCA by starting the electric power to the three-phase coil of the assist motor 5. As a result, the first supercharge-assist is performed (step S15).

In this way, as the deviation ΔACCP between the present value ACCP(n) of the depressing position of the accelerator pedal and the previous value ACCP(n-1) of the depressing position of the accelerator pedal or the rate of change of the accelerator position increases, the supercharge-assist amount SCA increases. As the supercharge-assist amount SCA increases, the electric power to the three-phase stator coil of the assist motor 5 increases. Further, as the electric power to the three-phase stator coil of the assist motor 5 increases, a rotational speed of the assist motor 5 increases. Accordingly, even if the engine rotational speed is in a low rotational speed region, the supercharge-assist by the assist motor 5 compensate for an insufficient amount of the actual supercharging pressure. Therefore, a rising characteristic of the actual supercharging pressure to the target supercharging pressure improves. At the same time, the follow-up characteristics of the actual supercharging pressure and the acceleration responsiveness to the rapid acceleration request by a driver improve.

Next, at step S16, it is determined whether or not a predetermined time T elapses after the first supercharge-assist control starts at step S15. When the determination result is NO, i.e., when the predetermined time T does not elapse after the first supercharge-assist control starts, the determination processing at step 16 is repeated. In addition, when the determination result at step S16 is YES, i.e., when the predetermined time T elapses after the first supercharge-assist control starts, the control routine in FIG. 5 is performed.

The predetermined time T may be a fixed value determined, by experiments or the like, by measuring the time for the actual supercharging pressure to reach the target supercharging pressure, in relation to the deviation ΔACCP between the present value ACCP(n) of the depressing position of the accelerator pedal and the previous value ACCP(n-1) of the depressing position of the accelerator pedal or the rate of change of the accelerator position, but excessive length of the predetermined time T makes it possible that the actual supercharging pressure overshoots in the direction of exceeding the target supercharging pressure.

Accordingly, as the deviation ΔACCP between the present value ACCP(n) of the depressing position of the accelerator pedal and the previous value ACCP(n-1) of the depressing position of the accelerator pedal, the rate of change of the accelerator position or a deviation between the actual supercharging pressure and the target supercharging pressure increases, the predetermined time T is made longer. On the other hand, as the deviation ΔACCP between the present value ACCP(n) of the depressing position of the accelerator pedal and the previous value ACCP(n-1) of the depressing position of the accelerator pedal, the rate of change of the accelerator position or a deviation between the actual supercharging pressure and the target supercharging pressure reduces, the predetermined time T is made shorter. Thus the predetermined time T may be a variable value.

Further, continuous supply of the maximum electric power (the maximum value of the electric power) to a motor winding portion such as the three-phase stator coil of the assist motor 5 for a long period of time causes a failure due to overheating of the motor winding portion. Therefore, as a temperature of the motor winding portion (or an environmental temperature in the circumference of the motor) is detected or estimated as a high value, the predetermined time T is made shorter. As a temperature of the motor winding portion (or an environmental temperature in the circumference of the motor) is detected or estimated as a low value, the predetermined time T is made be longer. Thus the predetermined time T may be a variable value.

In addition, when the supercharge-assist amount is forced to be reduced rapidly from the supercharge-assist amount SCA to the supercharge-assist amount SCB to be set as a lower value than the supercharge-assist amount SCA, the rotational speed of the assist motor 5 rapidly fluctuates to produce the step of the supercharge-assist force, causing possible rapid fluctuations of the engine output.

For preventing the problem of the rapid fluctuation of the engine output, a gradual or smooth change control of the assist amount which gradually reduces the supercharge-assist amount SCA during the later section (for example, a period from a certain time prior to when the predetermined time T ends to when the predetermined time T ends) of the period (initial acceleration stage) from when the first supercharge-assist control starts to when the predetermined time T elapses, i.e., during a transition period from the first supercharge-assist control to the second supercharge-assist control may be performed. This gradual change control of the assist amount allows smooth transition of the supercharge-assist amount of from the supercharge-assist amount SCA to the supercharge-assist amount SCB, thus solving the above problem.

The second supercharge-assist control (S9 in FIG. 3) for performing the supercharge-assist by the assist motor 5 based upon the supercharge-assist amount SCB for improving convergent characteristics of the actual supercharging pressure to the target supercharging pressure is performed as shown in FIG. 5. This control routine in FIG. 5 is repeated for each predetermined control cycle at the gradual acceleration request by a driver.

First, an injection amount correction amount determined based upon the fuel temperature Tf, the engine water temperature Tw and the like is applied to a basic injection amount set corresponding to the engine rotational speed NE and the accelerator position ACCP, thereby calculating a target injection amount (step S21). The target injection amount may be read from a data map provided in advance by measuring these relations based upon experiments or the like. Since the target injection amount is also calculated in an injector injection amount control, a value calculated in the injector injection amount control may be inputted at step S1. In this case, the calculation processing at step S21 can be eliminated. Next, at step S22 (supercharging pressure detecting device), an electric signal outputted from the supercharging pressure sensor 25 is inputted for detecting the actual supercharging pressure.

Next, at step S23 (supercharging pressure determination device), a target supercharging pressure is calculated from the engine rotational speed and the target injection amount (or acceleration opening). The target injection amount may be read from a data map provided in advance by measuring these relations based upon experiments or the like. Next, at step S24, a deviation AP between the actual supercharging pressure detected by the supercharging pressure sensor 25 and the target supercharging pressure is calculated. Next, at step S25 (second assist amount determination device), a supercharge-assist amount SCB is set based upon the deviation between the actual supercharging pressure and the target supercharging pressure. The supercharge-assist amount SCB is calculated as the supercharge-assist amount for improving convergent characteristics of the actual supercharging pressure to the target supercharging pressure. The supercharge-assist amount may be calculated as a target rotational speed for the present control cycle.

Next, at step S26, a target rotational speed corresponding to the supercharge-assist amount SCB calculated at step S25 is set. Next, at step S27, a basic electric power to the three-phase stator coil of the assist motor 5 required for making a motor speed (actual rotational speed) of the assist motor 5 be nearly equal to the target rotational speed is calculated. Next, at step S28, a basic electric power command is outputted to the controller 6 from the ECU 10.

Thereby, the controller 6 supplies the basic electric power (motor power: power) calculated at step S27 to the three-phase stator coil of the assist motor 5. That is, the supercharge-assist is performed by the assist motor 5 based upon the supercharge-assist amount SCB, by supplying the electric power to the three-phase coil of the assist motor 5 in such a way as to make the motor speed (actual rotational speed) of the assist motor 5 be nearly equal to the target rotational speed. As a result, the second supercharge-assist control is performed (step S29).

In this way, as the deviation between the target supercharging pressure and the actual supercharging pressure increases, the supercharge-assist amount SCB increases. As the supercharge-assist amount SCB increases, the electric power to the three-phase stator coil of the assist motor 5 increases. Further, as the electric power to the three-phase stator coil of the assist motor 5 increases, a rotational speed of the assist motor 5 increases. On the other hand, as the deviation between the target supercharging pressure and the actual supercharging pressure reduces, the supercharge-assist amount SCB reduces. As the supercharge-assist amount SCB reduces, the electric power to the three-phase stator coil of the assist motor 5 reduces. Further, as the electric power to the three-phase stator coil of the assist motor 5 reduces, a rotational speed of the assist motor 5 is decelerated. Accordingly, even if the engine rotational speed is in the low rotational speed region, the supercharge-assist by the assist motor 5 compensates for an insufficient amount of the actual supercharging pressure. Therefore, a rising characteristic of the actual supercharging pressure to the target supercharging pressure improves and at the same time, the convergent characteristics of the actual supercharging pressure to the target supercharging pressure improve.

As described above, in the engine control system with the turbocharger of the first preferred embodiment, the first supercharge-assist control which performs the supercharge-assist by the assist motor 5 based upon the supercharge-assist amount SCA for improving the follow-up characteristics of the actual supercharging pressure and the acceleration responsiveness to the rapid acceleration request by a driver immediately at a point when it is determined that the rapid acceleration request is made by the driver is performed for a period (initial acceleration time) until the predetermined time T elapses. Thereafter, the second supercharge-assist control which performs the supercharge-assist by the assist motor 5 based upon the supercharge-assist amount SCB for improving the convergent characteristics of the actual supercharging pressure to the target supercharging pressure is performed.

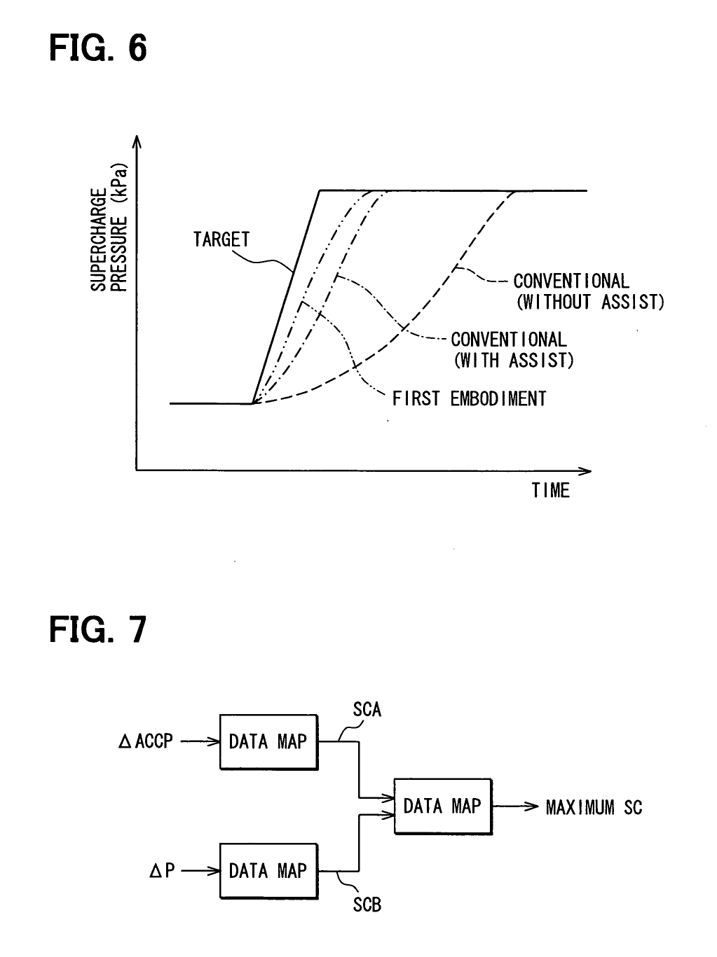

That is, when a driver largely depresses the accelerator pedal to make a rapid acceleration request, the first supercharge-assist control is performed with priority to the second supercharge-assist control for the period (initial acceleration stage) until the predetermined time T elapses after the rapid acceleration starts (the assist motor 5 is ON) and, in the later acceleration stage after the lapse of the predetermined time T, the second supercharge-assist control is performed with priority to the first supercharge-assist control. Hereby, as shown in a timing chart in FIG. 6, the follow-up characteristics of the actual supercharging pressure and the acceleration responsiveness to the acceleration request for quickly forcing the actual supercharging pressure to follow the target supercharging pressure immediately set to a high value based upon a rapid change (for example, the deviation between the present value and the previous value of the depressing position of the acceleration pedal or the rate of change of the accelerator position changes more than the first or second predetermined value) of an operating condition of the engine 1 as a result of the acceleration request (change of a depressing position of the accelerator pedal) by a driver and the convergent characteristics of the actual supercharging pressure to the target supercharging pressure for smoothly and quickly converging the actual supercharging pressure to the target supercharging pressure without the overshooting of the actual supercharging pressure in the direction of exceeding the target supercharging pressure can be achieved at the same time.

In FIG. 6, a solid line shows a target supercharging pressure from a low value to be set until the previous control cycle to a high value to be set in the present control cycle, produced by the acceleration request by a driver, a dotted line shows a conventional pressure rise of an actual supercharging pressure by the conventional supercharging pressure control without the supercharge-assist, a dashed line shows another conventional pressure rise form of an actual supercharging pressure by the conventional supercharging pressure control which performs supercharging pressure based upon such feedback-control as to make the actual supercharging pressure be nearly equal to the target supercharging pressure, and a chain-double dashed line shows an actual supercharging pressure by a supercharging pressure control of the first preferred embodiment (first and second supercharge-assist control). From FIG. 6, it is found out that the first preferred embodiment is more excellent in the follow-up characteristics of the actual supercharging pressure and the acceleration responsiveness to the acceleration request and also more excellent in the convergent characteristics of the actual supercharging pressure to the target supercharging pressure even if the first preferred embodiment is compared with two conventional supercharging pressure control.

In addition, from a point when the determination result by the determination processing at step S7 in FIG. 3 is YES, i.e., from a point when the rapid acceleration request is made by a driver, the first supercharge-assist control is to be immediately performed for a period (initial acceleration time) until the predetermined time T elapses, without determination of a target injection amount, recognition of an actual supercharging pressure, and determination of a target supercharging pressure. That is, supply of the maximum electric power to the three-phase stator coil of the assist motor 5 is designed to start. Hereby, the assist motor 5 can be ON immediately from a point when a driver depresses an accelerator pedal. As result, there is no time lag (responsive lag) between a point when a driver depresses an accelerator pedal and the acceleration request is made and a point when the supercharge-assist for assisting supercharging operations of the compressor 11 of the turbocharger 4 by the assist motor 5 is started. Hereby, the driver does not feel the time lag and sufficiently feels the supercharge-assist effect by the assist motor 5, making it possible to quickly increase the actual supercharging pressure. Further, as the deviation ΔACCP between the present value ACCP(n) of the depressing position of the accelerator pedal and the previous value ACCP(n-1) of the depressing position of the accelerator pedal, i.e., the rate of change of the accelerator position increases, since an actual fuel injection amount to be injected into the combustion chamber of each cylinder for the engine 1 is increased, an acceleration performance (acceleration responsiveness) can be further improved.

### Second Preferred Embodiment

In a second preferred embodiment, a supercharge-assist amount is calculated as a maximum value, i.e., the larger value of the supercharge-assist amount SCA and the supercharge-assist amount SCB as shown in FIG. 7.

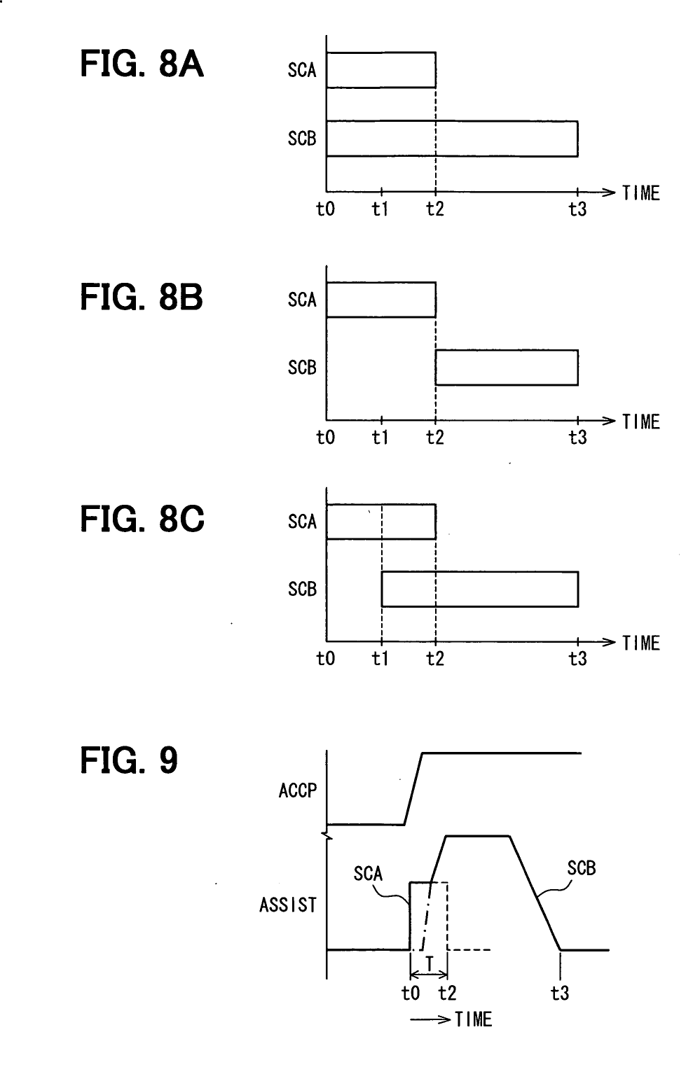

An ECU 10 of the second preferred embodiment includes a first assist amount determination device for setting a supercharge-assist amount SCA for improving follow-up characteristics of an actual supercharging pressure and acceleration responsiveness to an acceleration request and a second assist amount determination device for setting a supercharge-assist amount SCB for improving convergent characteristics of the actual supercharging pressure to a target supercharging pressure. Hereby, there are, as shown in FIGS. 8A to 8C, three ways of time lines for showing operations of a first supercharge-assist control which performs supercharge-assist by the assist motor 5 based upon the supercharge-assist amount SCA and a second supercharge-assist control which performs supercharge-assist by the assist motor 5 based upon the supercharge-assist amount SCB.

First, a control method 1 shown in FIG. 8A is a method in which the supercharge-assist amount SCA and the supercharge-assist amount SCB are at the same time calculated for a period (initial acceleration stage) from a point when it is determined that the rapid acceleration request is made to a point when a predetermined time elapses (elapse time T (predetermined time)=time t0 to time t2), and at the later acceleration stage after the elapse of the predetermined time T, only the supercharge-assist amount SCB is calculated. In the case of the control method 1, as the supercharge-assist amount provided from the assist motor 5 for a period (initial acceleration stage) from the acceleration start to the elapse of the predetermined time T it is desirable to adopt one larger value (maximum value of the supercharge-assist amount) of the supercharge-assist amount SCA and the supercharge-assist amount SCB, as shown in a control logic in FIG. 7 and in a timing chart shown in FIG. 9.

The supercharge-assist amount SCA in FIG. 8 is determined based upon the deviation ΔACCP between the present value ACCP(n) of the depressing position of the accelerator pedal and the previous value ACCP(n-1) of the depressing position of the accelerator pedal, the change amount per unit time of the accelerator position (rate of change of the accelerator position), or the change amount per unit time of the accelerator position (rate of change of the acceleration opening) and the depressing position of the accelerator pedal. In addition, the supercharge-assist amount SCB in FIG. 7 is determined based upon the deviation AP between the target supercharging pressure and the actual supercharging pressure. The supercharge-assist amount SCA and the supercharge-assist amount SCB may be read from a data map provided in advance by measuring these relations or may be calculated with use of a calculation formula.

Herein, the supercharge-assist amount SCA is a supercharge-assist amount for improving follow-up characteristics of an actual supercharging pressure and acceleration responsiveness to an acceleration request at the initial acceleration stage (predetermined time T=an elapse time from time t0 to time t2). Therefore, the supercharge-assist amount (SCA: a solid line and a dotted line in FIG. 9) is a value larger than the supercharge-assist amount (SCB: a dashed line in FIG. 9) calculated based upon at least the deviation between the target supercharging pressure and the actual supercharging pressure for the former section (period from time t0 to the vicinity of time t1) of the initial acceleration stage (period from time t0 to time t2), as shown in a timing chart in FIG. 9. Accordingly, also in this case, the first supercharge-assist control which performs the supercharge-assist by the assist motor 5 based upon the supercharge-assist amount SCA immediately at a point when it is determined that the acceleration request is made by a driver is to be performed for a period from time t0 to time t1.

In the control methods 2 and 3 in FIGS. 8B and 8C, a supercharge-assist amount provided from the assist motor 5 is, as shown in FIG. 7, calculated as the maximum value of the supercharge-assist amount or a sum thereof. The control method 2 shown in FIG. 8B is the control method of the first preferred embodiment. In the case of the control methods 1 to 3, for smooth transition from end of the first supercharge-assist control to start of the second supercharge-assist control, during the period of changing from the supercharge-assist amount SCA to the supercharge-assist amount SCB (during the transition period from the first supercharge-assist control to the second supercharge-assist control), i.e., during the later period of the initial acceleration stage, the supercharge-assist amount SCA may be gradually reduced.

For smooth transition from the supercharge-assist amount SCA set as a relatively higher value among the supercharge-assist amount SCA and the supercharge-assist amount SCB to the supercharge-assist amount SCB set as a relatively smaller value among the supercharge-assist amount SCA and the supercharge-assist amount SCB, the supercharge-assist amount SCA may be continuously reduced on a predetermined change rate per unit time (control cycle) or an assist amount-gradual changing control for step by step reducing the supercharge-assist amount SCA in a predetermined step amount per unit time (control cycle) may be performed for a period from time t0 to time t2 (the later section of the predetermined time T).

This case prevents a rapid fluctuation of the engine output caused by that, as the supercharge-assist amount is reduced from the supercharge-assist amount SCA to the supercharge-assist amount SCB at a time, the rotational speed of the assist motor 5 rapidly fluctuates to produce the step of the supercharge-assist force. This assist amount-gradual changing control is particularly effective in the method shown in FIG. 8C. In addition, the supercharge-assist amount SCB may be gradually increased at the initial stage of the second supercharge-assist control. This assist amount-gradual changing control is particularly effective in the method shown in FIG. 8C.

### Third Preferred Embodiment

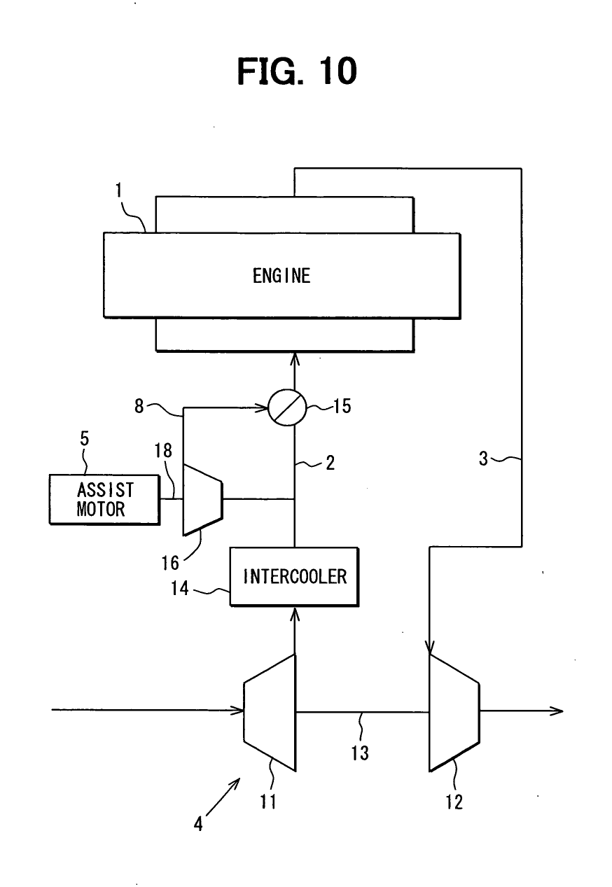

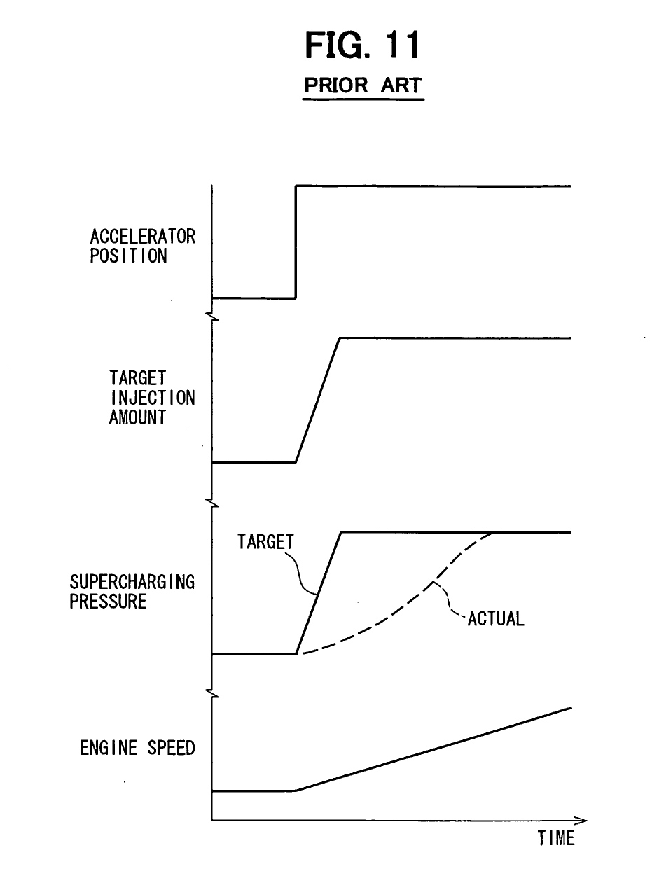

In a third preferred embodiment, as shown in FIG. 10, a bypass intake pipe 8 is connected to an engine intake pipe 2 communicating the an outlet of an intercooler 14 with an intake manifold of the engine 1, and an electromagnetic switch valve 15 is located at the convergent section between the engine intake pipe 2 and the bypass intake pipe 8. The electromagnetic switch valve 15 is driven by a control signal outputted from the ECU 10 (not shown) and changes an opening area of a bypass passage of the bypass intake pipe 8 or selectively opens/closes an intake air passage of the engine intake pipe 2 and the bypass passage of the bypass intake pipe 8.

An auxiliary compressor 16 having a structure similar to the compressor 11 of the turbocharger 4 is disposed in the bypass intake pipe 8. The auxiliary compressor 16 is mounted to one end of an output shaft (rotor shaft) 18 of the assist motor 5 in the central axis direction (axial direction) and is provided with a compressor wheel including a plurality of compressor blades. The compressor wheel is rotatably received in a compressor housing in such a way as to supercharge intake air flowing in the bypass intake pipe 8. An intake air supply path is formed in a spiral shape along the rotational direction of the compressor wheel in such a way as to surround an outer periphery of the compressor wheel.

In the third preferred embodiment, an electric compressor is constructed with the bypass intake pipe 8, the electromagnetic switch valve 15 and the auxiliary compressor 16. When the ECU 10 determines that the engine 1 is at an acceleration condition requiring supercharge-assist based upon a rate of change of the accelerator position ACCP or the like, the electromagnetic switch valve 15 is driven to open the bypass passage of the bypass intake pipe 8, and electric power is supplied to the three-phase stator coil of the assist motor 5 to obtain a predetermined supercharge-assist amount corresponding to the electric power. Hereby, the intake air supercharged by the compressor 11 of the turbocharger 4 is assist-supercharged by the compressor 16 to be aspired into the combustion chamber of each cylinder for the engine 1.

Hereby, even if a target supercharging pressure is set to an extremely high value in response to an acceleration request by a driver, as a rate of change of the accelerator position increases, the supercharge-assist amount increases, so that the rotational speed of the assist motor 5 is increased so as to quickly become close to a target rotational speed corresponding to a target supercharging pressure in response to the supercharge-assist amount. Therefore, even if the engine rotational speed is in a low-rotational speed region, the actual supercharging pressure can quickly follow the target supercharging pressure. Accordingly, an improvement in the follow-up characteristics of the actual supercharging pressure and the acceleration responsiveness to the acceleration request and an improvement in the convergent characteristics of the actual supercharging pressure to the target supercharging pressure can be achieved at the same time. In addition, the supercharge-assist by the assist motor 5 is started immediately from a point when a driver depresses an accelerator pedal, thereby further improving an acceleration performance.

(Modification)

In the preferred embodiments, the rotational speed of the assist motor 5 is controlled so as to be nearly equal to the target rotational speed corresponding to the supercharge-assist amount by adjusting the electric power (motor power) to be supplied to the three-phase stator coil of the assist motor 5 based upon the control signal (the basic electric power supply command, the maximum electric power supply command) of the ECU 10. However, the rotational speed of the assist motor 5 is controlled so as to be nearly equal to the target rotational speed corresponding to the supercharge-assist amount by adjusting an alternating voltage and its frequency to be outputted from an inverter based upon the control signal (the basic electric power supply command, the maximum electric power supply command) of the ECU 10.

In the preferred embodiments, when the deviation ΔACCP between the present value ACCP(n) of the depressing position of the accelerator pedal and the previous value ACCP(n-1) of the depressing position of the accelerator pedal, or the rate of change of the accelerator position is more than a first predetermined value, it is determined that the accelerator pedal is depressed to make the acceleration request, the assist motor 5 is switched into the supercharge-assist mode (either one of the first supercharge-assist control and the second supercharge-assist control or both thereof). However, when a rate of change of a target injection amount or a rate of change of a target fuel pressure is more than a first predetermined value, it is determined that the accelerator pedal is depressed to make the acceleration request, and the assist motor 5 may be switched into the supercharge-assist mode (either one of the first supercharge-assist control and the second supercharge-assist control or both thereof).

When the deviation ΔACCP between the present value ACCP(n) of the depressing position of the accelerator pedal and the previous value ACCP(n-1) of the depressing position of the accelerator pedal, or the rate of change of the accelerator position is more than a second predetermined value greater than the first predetermined value, it is determined that the accelerator pedal is depressed to make the acceleration request, and the assist motor 5 is switched into the first supercharge-assist control. However, when a rate of change of a target injection amount or a rate of change of a target fuel pressure is more than a second predetermined value greater than the first predetermined value, it is determined that the accelerator pedal is depressed to make the acceleration request, and the assist motor 5 may be switched into the first supercharge-assist control.

In addition, when a rate of change of the accelerator pedal is less than a third predetermined value smaller than the first predetermined value, it is determined that the engine 1 is at a decelerating condition where the accelerator pedal is returned back, and the assist motor 5 may be switched into the regenerative power generating mode. In addition, when a condition of a road where a vehicle travels is an upward slope, the assist motor 5 may be switched into the supercharge-assist mode (either one of the first supercharge-assist control and the second supercharge-assist control or both thereof). When a condition of a road where a vehicle travels is a downward slope, the assist motor 5 may be switched into the regenerative power generating mode.

In the preferred embodiments, an example using an alternating current motor such as the three-phase induction electric motor (wound-rotor induction electric motor) as the assist motor 5 is explained. However, a squirrel-cage induction electric motor, a brushless DC motor or a brush DC motor may be used as the assist motor 5. In this case, the electric motor may be a motor equipped only with a function of the electric motor. In addition, a gear reduction mechanism for decelerating a rotational speed of an output shaft of the assist motor 5 so as to be in a predetermined reduction ratio may be disposed between the output shaft of the assist motor 5 and the rotor shaft (turbine shaft) 13.

In the preferred embodiments, a supercharge-assist control system of the present invention is applied to an engine control system with a turbocharger, but a supercharge-assist control system of the present invention may be applied to a supercharging pressure control apparatus for an internal combustion engine or a turbocharger control apparatus with an electric motor (control apparatus of an electric supercharger). In addition, there is explained an example where as a supercharger, a turbocharger with an electric motor for supercharging intake air aspired into the combustion chamber of each cylinder for the engine 1 by using exhaust gas energy of the engine 1 is adopted, but a supercharger with an electric motor for supercharging intake air aspired into the combustion chamber of each cylindcer for the engine 1 by using drive torque of a drive motor may be adopted.

In the preferred embodiments, the target supercharge-assist amount is calculated based upon the deviation between the actual supercharging pressure detected by the supercharging pressure sensor 25 and the target supercharging pressure, then the target rotational speed in the present control cycle is calculated in accordance with the supercharge-assist amount and next the basic electric power to the three-phase stator coil of the assist motor 5 required for making the actual rotational speed of the assist motor 5 be nearly equal to the target rotational speed is calculated. However, a supercharge-assist amount corresponding to a deviation between the actual supercharging pressure (intake pressure) and the target supercharging pressure, a target (new) intake air amount, an intake pressure, an intake temperature, an engine rotational speed, a rate of change of the accelerator position, a target supercharging pressure or driver request torque, is calculated. Next a target rotational speed in the present control cycle is calculated based upon the supercharge-assist amount. The basic electric power to the three-phase stator coil of the assist motor 5 required for making the actual rotational speed of the assist motor 5 be nearly equal to the target rotational speed may be calculated.

In addition, a target supercharge-assist amount is calculated based upon the deviation between the actual supercharging pressure detected by the supercharging pressure sensor 25 and the target supercharging pressure. Next, a basic electric power to the three-phase stator coil of the assist motor 5 required for making the actual supercharge-assist amount of the assist motor 5 be nearly equal to the target supercharge-assist amount may be calculated. In addition, a supercharge-assist amount is set (calculated) by the first and second assist amount determination devices of the ECU 10, the supercharge-assist amount is converted into an electric signal to be outputted to the controller 6, the electric signal is converted into a electric power, which is outputted to the three-phase stator coil of the assist motor 5, the electric signal is converted to electric power to the three-phase stator coil of the assist motor 5 in the controller 6 and the electric power may be supplied to the three-phase stator coil of the assist motor 5.

A supercharge-assist amount SCB may be feedback-controlled as the supercharge-assist control (supercharging pressure control) by the assist motor 5, the supercharge-assist amount SCB may be feedback-controlled based upon the deviation between the actual supercharging pressure of the assist motor 5 and the target supercharging pressure. Further, the supercharge-assist amount SCB may be feedback-controlled based upon the deviation between the actual electric power to be supplied to the three-phase stator coil of the assist motor 5 and the basic electric power.

While only the selected preferred embodiments have been chosen to illustrate the present invention, it will be apparent to those skilled in the art from this disclosure that various changes and modifications can be made therein without departing from the scope of the invention as defined in the appended claims. Furthermore, the foregoing description of the preferred embodiments according to the present invention is provided for illustration only, and not for the purpose of limiting the invention as defined by the appended claims and their equivalents.

What is claimed is:

1. A supercharge-assist control system comprising:
a supercharger that supercharges intake air aspired into a cylinder of an engine;
a motor that rotates and drives the supercharger;
a supercharging pressure detecting device that detects a supercharging pressure produced in an engine intake pipe by the supercharger;
a supercharging pressure determination device that changes a target supercharging pressure corresponding to a change of an operating condition for the engine; and
a motor control apparatus that controls electric power to be supplied to the motor so that an actual supercharging pressure detected by the supercharging pressure detecting device be nearly equal to the target supercharging pressure, thus controlling a supercharge-assist amount by the motor,
wherein the motor control apparatus inlcudes:
an acceleration request determination device that determines whether or not an acceleration request is made;
a first assist amount determination device that sets a supercharge-assist amount for improving follow-up characteristics of the actual supercharging pressure and acceleration responsiveness to the acceleration request; and
a second assist amount determination device that sets a supercharge-assist amount for improving convergent characteristics of the actual supercharging pressure to the target supercharging pressure, and
wherein, when it is determined by the acceleration request determination device that the acceleration request is made, first supercharge-assist control that performs the supercharge-assist by the motor based upon the supercharge-assist amount determined by the first assist amount determination device and a second supercharge-assist control that performs the supercharge-assist by the motor based upon the supercharge-assist amount determined by the second assist amount determination device are selectively applied based upon a change amount per unit time of an operating condition for the engine, a deviation between the actual supercharging pressure detected by the supercharging pressure detecting device and the target supercharging pressure determined by the supercharging pressure determination device or an elapse of time from a point when the acceleration request is made.

2. The supercharge-assist control system according to claim 1, wherein the acceleration request determination device determines that the acceleration request is made when the a depressing speed of an accelerator pedal, a rate of change of an accelerator position, a rate of change of a target injection amount or a rate of change of a target fuel pressure is more than a predetermined value.

3. The supercharge-assist control system according to claim 1, wherein:
the motor control apparatus includes a depressing position detecting device that detects a depressing position of the accelerator pedal, and a depressing position memory device that stores the depressing position of the accelerator pedal detected by the depressing position detecting device; and
the first assist amount determination device sets the supercharge-assist amount based upon a deviation between the previous value of the depressing position of the accelerator pedal stored by the depressing position memory device and the present value of the depressing position of the accelerator pedal detected by the depressing position detecting device.

4. The supercharge-assist control system according to claim 1, wherein the second assist amount determination device sets the supercharge-assist amount based upon the deviation between the actual supercharging pressure detected by the supercharging pressure detecting device and the target supercharging pressure determined by the supercharging pressure determination device.

5. The supercharge-assist control system according to claim 1, wherein the motor control apparatus performs the first supercharge-assist control immediately from a point when it is determined by the acceleration request determination device that the acceleration request is made.

6. The supercharge-assist control system according to claim 1, wherein the motor control apparatus assumes one of a larger value of the supercharge-assist amount determined by the first assist amount determination device and the supercharge-assist amount determined by the second assist amount determination device as a maximum value of the supercharge-assist amount at an initial acceleration stage and performs the supercharge-assist by the motor based upon the maximum value of the supercharge-assist amount.

7. The supercharge-assist control system according to claim 1, wherein the motor control apparatus performs the first supercharge-assist control with priority over the second supercharge-assist control at an initial acceleration stage, and the second supercharge-assist control with priority over the first supercharge-assist control at a subsequent acceleration stage.

8. The supercharge-assist control system according to claim 7, wherein the motor control apparatus performs both the first supercharge-assist control and the second supercharge-assist control during a transition period from the initial acceleration stage to the subsequent acceleration stage.

9. The supercharge-assist control system according to claim 6, wherein:
the initial acceleration stage is a period from a point when it is determined by the acceleration request determination device that the acceleration request is made to a point when a predetermined time elapses;
the motor control apparatus performs the supercharge-assist by the motor based upon the maximum value of the supercharge-assist amount or the supercharge-assist amount determined by the first assist amount determination device or by the second assist amount determination device for the period from the point when the acceleration request is made to the point when the predetermined time elapses; and
the predetermined time is set to be longer as the rate of change per unit time of the operating condition for the engine or the deviation between the actual supercharging pressure detected by the supercharging pressure detecting device and the target supercharging pressure determined by the supercharging pressure determination device increases.

10. The supercharge-assist control system according to claim 1, wherein the motor control apparatus performs an assist amount -gradual changing control during a transition period from the first supercharge-assist control to the second supercharge-assist control, which gradually reduces the supercharge-assist amount to be determined by the first assist amount determination device, thus transferred to the supercharge-assist amount to be determined by the second assist amount determination device.

11. A method of controlling supercharge-assist for an engine having a supercharger and a motor for the supercharger, the method comprising:
detecting a supercharging pressure produced in an engine intake pipe by the supercharger;
changing a target supercharging pressure corresponding to a change of an operating condition for the engine;
controlling electric power to be supplied to the motor so that an actual supercharging pressure detected be nearly equal to the target supercharging pressure, thus controlling a supercharge-assist amount by the motor;
determining whether or not an acceleration request is made;
setting a first supercharge-assist amount for improving follow-up characteristics of the actual supercharging pressure and acceleration responsiveness to the acceleration request;
setting a second supercharge-assist amount for improving convergent characteristics of the actual supercharging pressure to the target supercharging pressure; and
selectively switching, when it is determined that the acceleration request is made, a first supercharge-assist control which performs the supercharge-assist by the motor based upon the first supercharge-assist amount and a second supercharge-assist control which performs the supercharge-assist by the motor based upon the second supercharge-assist amount, based upon a change amount per unit time of an operating condition for the engine, a deviation between the detected actual supercharging pressure and the target supercharging pressure or an elapse time from a point when the acceleration request is made.

12. The method according to claim 11, further comprising:
determining whether the requested acceleration is a rapid acceleration or a smooth acceleration,
wherein the first supercharge-assist control and the second supercharge-assist control are selected in order when the requested acceleration is the rapid acceleration, and only the second supercharge-assist control is selected when the requested acceleration is the smooth acceleration.
